(19) United States
(12) Patent Application Publication
(10) Pub. No.: US 2025/0141552 A1
(43) Pub. Date: May 1, 2025

(54) OPTICAL TRANSMISSION APPARATUS AND COMMUNICATION METHOD

(71) Applicant: NIPPON TELEGRAPH AND TELEPHONE CORPORATION, Tokyo (JP)

(72) Inventors: Naotaka SHIBATA, Musashino-shi, Tokyo (JP); Shin KANEKO, Musashino-shi, Tokyo (JP)

(73) Assignee: NIPPON TELEGRAPH AND TELEPHONE CORPORATION, Tokyo (JP)

(21) Appl. No.: 18/691,300

(22) PCT Filed: Sep. 17, 2021
(86) PCT No.: PCT/JP2021/034400

§ 371 Date: Mar. 12, 2024

(51) Int. Cl. H04B 10/27; H04J 14/02; H04Q 11/00

(52) U.S. Cl. CPC H04B 10/27; H04J 14/02; H04Q 11/0005

(57) ABSTRACT

An optical transmission device includes a wavelength cross connection unit that receives an optical signal transmitted from a first optical transmission device, separates the input optical signal according to a wavelength, and outputs each of the separated optical signals from a port corresponding to the wavelength, and an optical switch that outputs an optical signal output from the wavelength cross connection unit from a port to which a destination subscriber device is connected, in which the wavelength cross connection unit outputs the optical signal toward the optical switch in a case where the optical signal is an optical signal addressed to a subscriber device connected under control of a host device, and outputs the optical signal toward a second optical transmission device different from the first optical transmission device in a case where the optical signal is not an optical signal addressed to a subscriber device connected under control of the host device.

### TECHNICAL FIELD

The present invention relates to a technology of an optical transmission device and a communication method.

### BACKGROUND ART

An optical transmission device capable of relaying an optical signal according to a destination while reducing a delay has been proposed (see, for example, Patent Literature 1). FIG. 10 is a diagram illustrating a specific example of a conventional optical transmission device 90. The optical transmission device 90 includes an optical switch 91. The optical switch 91 outputs the input optical signals from one or more subscriber devices to any one of the direction of the transmission paths.

FIG. 11 is a diagram illustrating a configuration example of a conventional optical communication system 900. The optical communication system 900 includes a plurality of optical transmission devices 90. The optical communication system 900 in FIG. 11 includes four optical transmission devices 90. One or a plurality of subscriber devices 20 is connected to each optical transmission device 90. Each subscriber device 20 communicates with another subscriber device 20 via the optical transmission device 90 to which the host device is connected and the optical transmission device 90 to which another subscriber device 20 that will be a communication partner is connected.

### CITATION LIST

### Patent Literature

Patent Literature 1: WO 2021/131202 A

### SUMMARY OF INVENTION

### Technical Problem

In the optical communication system 900, in order for the subscriber device 20 connected to a certain optical transmission device 90 to communicate with another subscriber device 20, the optical transmission device 90 to which the host device (the subscriber device 20) is connected and the subscriber device 20 that will be a communication partner thereof need to be connected. Therefore, in order to realize communication between all the subscriber devices 20, all the optical transmission devices 90 need to be connected to each other by optical fibers. For example, in each optical transmission device 90 illustrated in FIG. 11, six fibers are required to realize communication between all the subscriber devices 20. Since a large number of fibers are required, in a case where the laid fibers are insufficient, it is necessary to lay new fibers, and a large amount of cost including construction is generated. In addition, even in a case a where the laid fibers are sufficient, since a large number of existing fibers are used, there is a possibility that the fibers will be insufficient when it is desired to newly use the fibers. In addition, in a case where a business operator who installs the present optical transmission device borrows and uses, for example, a dark fiber, a fiber borrowing cost occurs. In this case, in the present configuration in which the fibers are connected between all optical transmission devices, the fiber borrowing cost increases.

In view of the above circumstances, an object of the present invention is to provide a technique capable of realizing an optical communication system with reduced cost.

### Solution to Problem

An aspect of the present invention is an optical transmission device including a wavelength cross connection unit that receives an optical signal transmitted from a first optical transmission device, separates the input optical signal according to a wavelength, and outputs each of the separated optical signals from a port corresponding to the wavelength, and an optical switch that outputs an optical signal output from the wavelength cross connection unit from a port to which a destination subscriber device is connected, in which the wavelength cross connection unit outputs the optical signal toward the optical switch in a case where the optical signal is an optical signal addressed to a subscriber device connected under control of a host device, and outputs the optical signal toward a second optical transmission device different from the first optical transmission device in a case where the optical signal is not an optical signal addressed to a subscriber device connected under control of the host device.

An aspect of the present invention is a communication method to be executed by an optical transmission device including a wavelength cross connection unit and a plurality of optical switches, the method including receiving an optical signal transmitted from a first optical transmission device, separating the input optical signal according to a wavelength, outputting each of the separated optical signals from a port corresponding to the wavelength by the wavelength cross connection unit, outputting an optical signal output from the wavelength cross connection unit from a port to which a destination subscriber device is connected by the optical switch, and outputting the optical signal toward the optical switch in a case where the optical signal is an optical signal addressed to a subscriber device connected under control of a host device, and outputting the optical signal toward a second optical transmission device different from the first optical transmission device in a case where the optical signal is not an optical signal addressed to a subscriber device connected under control of the host device by the wavelength cross connection unit.

### Advantageous Effects of Invention

According to the present invention, it is possible to realize an optical communication system with reduced cost.

### BRIEF DESCRIPTION OF DRAWINGS

FIG. 1 is a diagram illustrating a configuration example of an optical transmission device 10 according to a first embodiment.

FIG. 2 is a flowchart illustrating an outline of a flow of processing related to an optical signal addressed to a subordinate subscriber device 20 among processing of an optical transmission device 10 in downstream communication (communication from a transmission path side to a subscriber device side).

FIG. 3 is a flowchart illustrating an outline of a flow of processing of transferring an optical signal to another optical transmission device 10 among processing of the optical transmission device 10 in downstream communication (communication from a transmission path side to a subscriber device side).

FIG. 4 is a flowchart illustrating an outline of a processing flow of the optical transmission device 10 in upstream communication (communication from a subscriber device side to a transmission path side).

FIG. 5 is a diagram illustrating a specific example of an optical transmission system 100 configured using a plurality of optical transmission devices 10.

FIG. 6 is a diagram illustrating a configuration example of an optical transmission device 10 according to a second embodiment.

FIG. 7 is a diagram illustrating a configuration example of an optical transmission device 10 according to a third embodiment.

FIG. 8 is a diagram illustrating a specific example of a configuration performed using different optical fibers for upstream communication and downstream communication in a transmission path.

FIG. 9 is a diagram illustrating a specific example of a configuration performed using different optical fibers for upstream communication and downstream communication in a transmission path.

FIG. 10 is a diagram illustrating a specific example of a conventional optical transmission device 90.

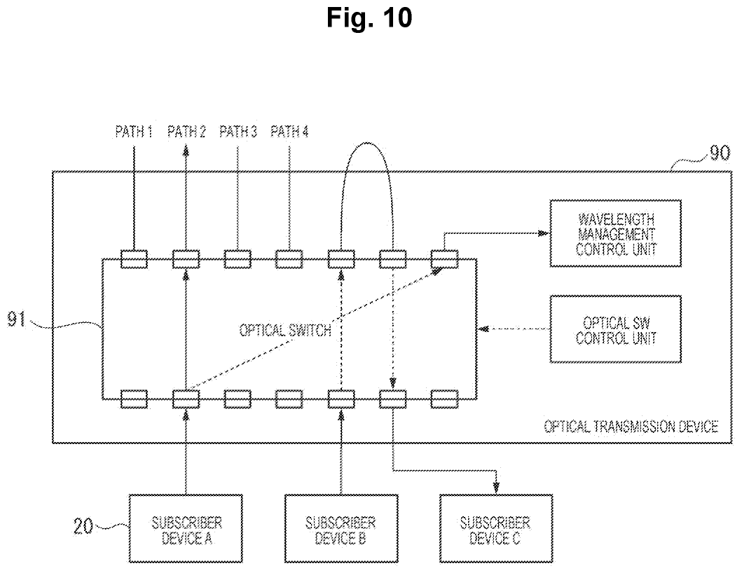

FIG. 11 is a diagram illustrating a configuration example of a conventional optical communication system 900.

### DESCRIPTION OF EMBODIMENTS

Embodiments of the present invention will be described in detail with reference to the drawings.

### First Embodiment

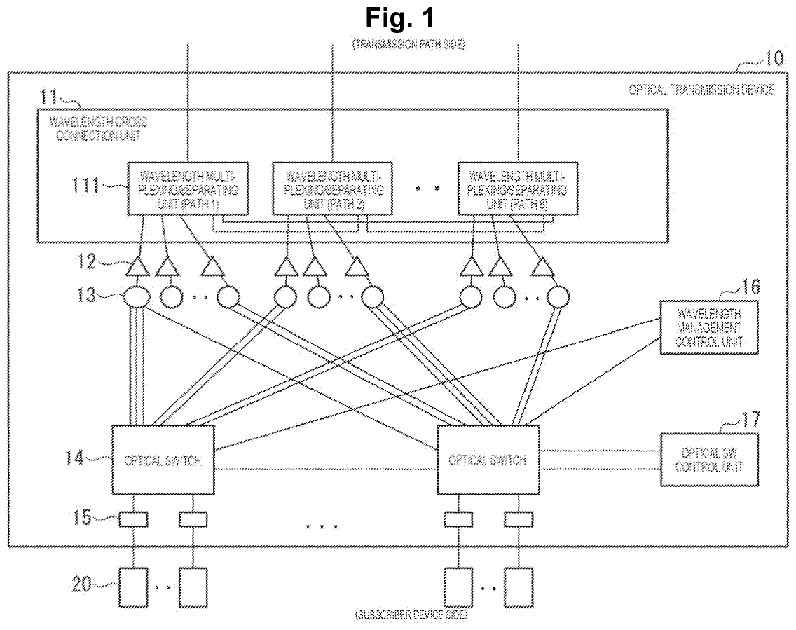

FIG. 1 is a diagram illustrating a configuration example of an optical transmission device 10 according to a first embodiment. The optical transmission device 10 is connected to a transmission path and a subscriber device. The optical transmission device 10 is connected to another optical transmission device 10 via a transmission path including an optical fiber. In FIG. 1, a transmission path is positioned above the optical transmission device 10. A position relatively close to a transmission path is referred to as a “transmission path side”. A subscriber device 20 is positioned below the optical transmission device 10. A position relatively close to the subscriber side is referred to as a “subscriber device side”. The optical transmission device 10 includes a wavelength cross connection unit 11, an internal amplifier 12, a coupler 13, an optical switch 14, and a wavelength tunable filter 15.

The wavelength cross connection unit 11 includes a wavelength multiplexing/separating unit 111 corresponding to the number of paths to which the optical transmission device 10 is connected (the same number as the number of paths). In the example of FIG. 1, since the optical transmission device 10 is connected to eight paths, the wavelength cross connection unit 11 includes eight wavelength multiplexing/separating units 111. An optical fiber corresponding to a path is connected to the transmission path side of the wavelength multiplexing/separating unit 111. The wavelength multiplexing/separating unit 111 separates the optical signal input from the transmission path side for each predetermined wavelength, and outputs the optical signal from a port on the side of the subscriber device corresponding to the wavelength. Each wavelength of the separated optical signal is, for example, a wavelength of an optical signal received by the subscriber device 20 connected to the host device.

The wavelength multiplexing/separating unit 111 performs wavelength multiplexing on an optical signal input from a port on the subscriber device side, and outputs the multiplexed optical signal from the transmission path side. The wavelength multiplexing/separating unit 111 is configured using, for example, a wavelength selective switch (WSS).

The subscriber device side of the wavelength demultiplexing unit 111 is connected to each of the other wavelength multiplexing/separating unit 111 included in the same wavelength cross connection unit 11. For example, in the case of FIG. 1, since the wavelength cross connection unit 11 includes eight wavelength multiplexing/separating units 111, one wavelength multiplexing/separating unit 111 is connected to seven wavelength multiplexing/separating units 111. The wavelength multiplexing/separating unit 111 and the other wavelength multiplexing/separating unit 111 are connected by at least one optical fiber. The allocated wavelength of the signal addressed to the subscriber device 20 connected to another optical transmission device 10 is different from that of the signal addressed to the subscriber device 20 connected to the host device (optical transmission device 10). A signal addressed to the subscriber device 20 connected to another optical transmission device 10 is output to the wavelength multiplexing/separating unit 111 corresponding to a path connected to another optical transmission device 10.

The subscriber device side of the wavelength multiplexing/separating unit 111 is further connected to one or a plurality of internal amplifiers 12. A signal addressed to the subscriber device 20 connected to the host device (the optical transmission device 10) is output from a port (a port on the subscriber device side of the wavelength multiplexing/separating unit 111) to which the internal amplifier 12 corresponding to the subscriber device 20 as a destination is connected.

The internal amplifier 12 amplifies a signal input through one port and outputs the amplified signal from the other port. The amplification processing of the internal amplifier 12 can compensate for the loss caused by the coupler 13.

The coupler 13 is a specific example of the multiplexer/demultiplexer. The subscriber device side has a plurality of ports, and the transmission path side has a smaller number (for example, one) of ports than the subscriber device side. A wavelength management control unit 16 sets the wavelengths of the subscriber devices 20 connected to the same coupler to be different from each other. Therefore, the coupler 13 performs wavelength division multiplexing (WDM) in the uplink communication. The coupler 13 multiplexes a plurality of signals input from the subscriber device side and outputs the multiplexed signals from the transmission path side. The plurality of signals input from the subscriber device side to the coupler 13 have different wavelengths. Therefore, the coupler 13 substantially performs wavelength multiplexing processing. The coupler 13 branches a signal input from the transmission path side and outputs the signal from the subscriber device side.

The larger the number of ports on the subscriber device side of the coupler 13, the more the subscriber devices 20 can be accommodated. However, in that case, since attenuation (loss) of the optical signal increases, amplification in the internal amplifier 12 is essential. On the other hand, the attenuation (loss) of the optical signal decreases as the number of ports on the subscriber device side of the coupler 13 decreases. Therefore, it is not necessary to include the internal amplifier 12, and an increase in device cost can be suppressed.

The optical switch 14 outputs an optical signal input from a certain port (input port) from another port (output port). A relationship between an input port and an output port in the optical switch 14 can be dynamically changed. The relationship between the input port and the output port in the optical switch 14 is controlled by an optical SW control unit 17. Specifically, it is as follows. The wavelength management control unit 16 dynamically allocates a use wavelength of the subscriber device 20. The optical SW control unit 17 controls connection (wiring) between an input port and an output port in the optical switch 14 so that a signal of the subscriber device 20 is transmitted to a transmission path of a desired path. The optical switch 14 outputs, for example, a signal input from the transmission path side to the wavelength tunable filter 15 under the control of the optical SW control unit 17. The optical switch 14 outputs, for example, a signal input from the subscriber device side from a port on the transmission path side connected to the wavelength multiplexing/separating unit 111 according to the destination path.

The wavelength tunable filter 15 transmits only a signal with a wavelength corresponding to the subscriber device 20 connected to the host device. The wavelength tunable filter 15 blocks a signal with a wavelength that does not correspond to the subscriber device 20 connected to the host device. The wavelength tunable filter 15 filters a signal input from the subscriber device side and then outputs the signal to the optical switch 14. The wavelength tunable filter 15 filters a signal input from the transmission path side and then outputs the signal to the subscriber device 20. At the time of initial connection, that is, before the wavelength management control unit 16 assigns the wavelength to the subscriber device 20, a signal may arrive from the subscriber device 20 at an arbitrary wavelength. Therefore, the wavelength tunable filter 15 needs to be set to be able to transmit an arbitrary wavelength. In a case where the wavelength to be used at the time of initial connection is predetermined, the wavelength tunable filter 15 may be set to transmit the wavelength.

The wavelength management control unit 16 allocates a wavelength used for communication to each subscriber device 20 according to a destination. The wavelength management control unit 16 stores, for example, a wavelength management table. The wavelength management table is data indicating a wavelength allocated to each subscriber device 20. The wavelength management control unit 16 may allocate a wavelength to each subscriber device 20 according to the content of the wavelength management table. The wavelength management control unit 16 may perform wavelength allocation using, for example, an auxiliary management and control channel (AMCC) function.

The optical SW control unit 17 determines optical paths of the subscriber device 20 and the opposing subscriber device 20, and records the determined optical path in the optical path management table. The optical SW control unit 17 controls the wiring of the optical switch 14 to which each subscriber device 20 is connected so that the determined optical path is formed. The optical SW control unit 17 may control each optical switch 14 using, for example, an electrical signal.

The subscriber device 20 is an information device that performs communication. The subscriber device 20 communicates with another subscriber device 20 via a transmission path. The subscriber device 20 includes, for example, an optical transceiver. The optical transceiver may be configured using, for example, a wavelength-tunable optical transceiver. In this case, the subscriber device 20 can perform communication at an arbitrary wavelength. The optical transceiver may be an optical transceiver with an AMCC function. In this case, the use wavelength can be controlled via the control signal superimposed by the AMCC.

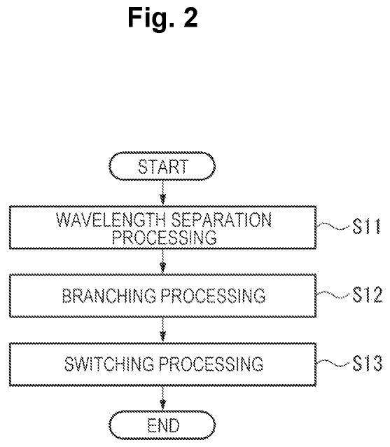

FIG. 2 is a flowchart illustrating an outline of a flow of processing related to an optical signal addressed to the subordinate subscriber device 20 among processing of the optical transmission device 10 in downstream communication (communication from a transmission path side to a subscriber device side). First, when an optical signal is input to the optical transmission device 10 from the transmission path side, the optical signal is input to the wavelength multiplexing/separating unit 111 corresponding to the path from which the optical signal has arrived. The wavelength multiplexing/separating unit 111 performs wavelength separation processing on the input optical signal (step S11). The wavelength multiplexing/separating unit 111 outputs each optical signal subjected to wavelength separation from a port corresponding to a destination (wavelength) to the internal amplifier 12. The internal amplifier 12 performs amplification processing on the input optical signal. The internal amplifier 12 outputs the amplified optical signal to the coupler 13.

The coupler 13 performs branching processing on the optical signal input from the internal amplifier 12 (step S12). The coupler 13 branches the optical signal input from the internal amplifier 12 into a plurality of optical fibers and outputs the optical signal. The optical switch 14 receives the optical signal output from the coupler 13. The optical switch 14 outputs the input optical signal from the corresponding port according to the control of the optical SW control unit 17 (step S13). The wavelength tunable filter 15 passes an optical signal with a wavelength allocated to the connected subscriber device 20 and blocks an optical signal with another wavelength. The subscriber device 20 receives the optical signal output from the optical switch 14 via the wavelength tunable filter 15.

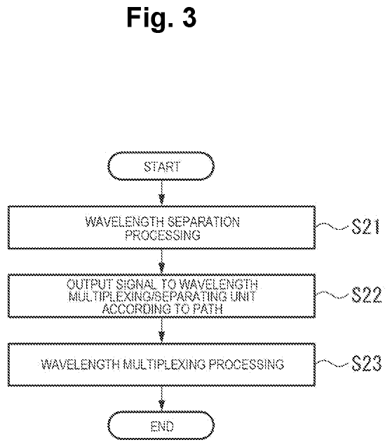

FIG. 3 is a flowchart illustrating an outline of a flow of processing of transferring an optical signal to another optical transmission device 10 among processing of the optical transmission device 10 in downstream communication (communication delivered from a subscriber device side). First, when an optical signal is input to the optical transmission device 10 from the transmission path side, the optical signal is input to the wavelength multiplexing/separating unit 111 corresponding to the path from which the optical signal has arrived. The wavelength multiplexing/separating unit 111 performs wavelength separation processing on the input optical signal (step S21). The wavelength multiplexing/separating unit 111 outputs each optical signal subjected to wavelength separation from a port corresponding to a destination (wavelength). In the case of FIG. 3, the received optical signal is an optical signal addressed to the subscriber device 20 connected to another optical transmission device 10. Therefore, the wavelength multiplexing/separating unit 111 outputs an optical signal to the wavelength multiplexing/separating unit 111 of a path corresponding to a transmission path to which another optical transmission device 10 as a destination is connected (step S22). The wavelength multiplexing/separating unit 111 that has received the optical signal from the other wavelength multiplexing/separating unit 111 performs wavelength multiplexing processing on the optical signal together with the optical signal input from the other port on the side of the subscriber device (step S23). The wavelength multiplexing/separating unit 111 outputs the wavelength-multiplexed optical signal from the port on the transmission path side to the transmission path.

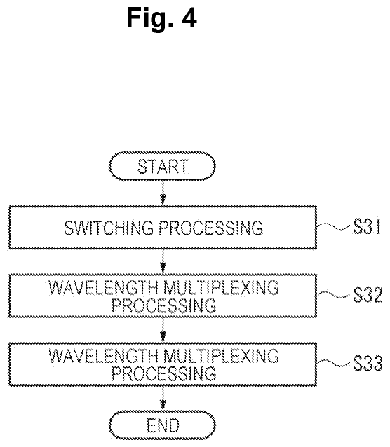

FIG. 4 is a flowchart illustrating an outline of a processing flow of the optical transmission device 10 in upstream communication (communication from a subscriber device side to a transmission path side). First, when an optical signal transmitted from the subscriber device 20 is input to the optical transmission device 10, the optical signal is input to the wavelength tunable filter 15. The wavelength tunable filter 15 passes an optical signal with a wavelength allocated to the connected subscriber device 20 and blocks an optical signal with another wavelength. The optical switch 14 receives the optical signal transmitted from the subscriber device 20 via the wavelength tunable filter 15. Under the control of the optical SW control unit 17, the optical switch 14 outputs the optical signal transmitted from each subscriber device 20 from the port corresponding to the destination of each optical signal (step S31). The port corresponding to the destination of the optical signal is a port connected to the wavelength multiplexing/separating unit 111 corresponding to a path to be the destination of the optical signal.

The optical signal output from the optical switch 14 is input to the coupler 13 corresponding to the output port. The coupler 13 multiplexes one or a plurality of optical signals input thereto and outputs the multiplexed optical signals to the internal amplifier 12 (step S32). The internal amplifier 12 performs amplification processing on the input optical signal from the coupler 13. The internal amplifier 12 outputs the amplified optical signal to the wavelength multiplexing/separating unit 111. The wavelength multiplexing/separating unit 111 performs wavelength multiplexing processing on the input optical signal together with the optical signal input from another port (step S33). The wavelength multiplexing/separating unit 111 outputs the wavelength-multiplexed optical signal from the port on the transmission path side to the transmission path.

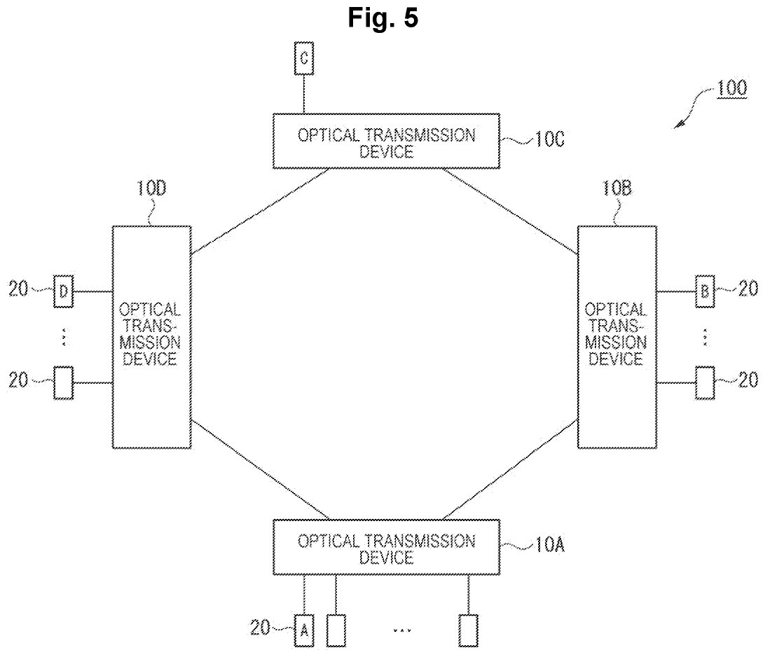

FIG. 5 is a diagram illustrating a specific example of an optical transmission system 100 configured using a plurality of optical transmission devices 10. In the example of FIG. 5, the optical transmission system 100 is configured using four optical transmission devices 10 (10A to 10D). One or a plurality of subscriber devices 20 is connected to each optical transmission device 10. Each optical transmission device 10 includes the wavelength cross connection unit 11. The wavelength cross connection unit 11 outputs an optical signal addressed to the subscriber device 20 connected under its control to the optical switch 14 to which the subscriber device 20 serving as a destination is connected. On the other hand, the wavelength cross connection unit 11 transmits (transfers) an optical signal addressed to the subscriber device 20 connected under the control of another optical transmission device 10 to a transmission path to which another optical transmission device 10 is connected. Therefore, communication can be performed via another optical transmission device 10 without individually connecting the optical transmission devices 10 by optical fibers. As a result, the number of optical fibers required for constructing the optical transmission system 100 can be reduced.

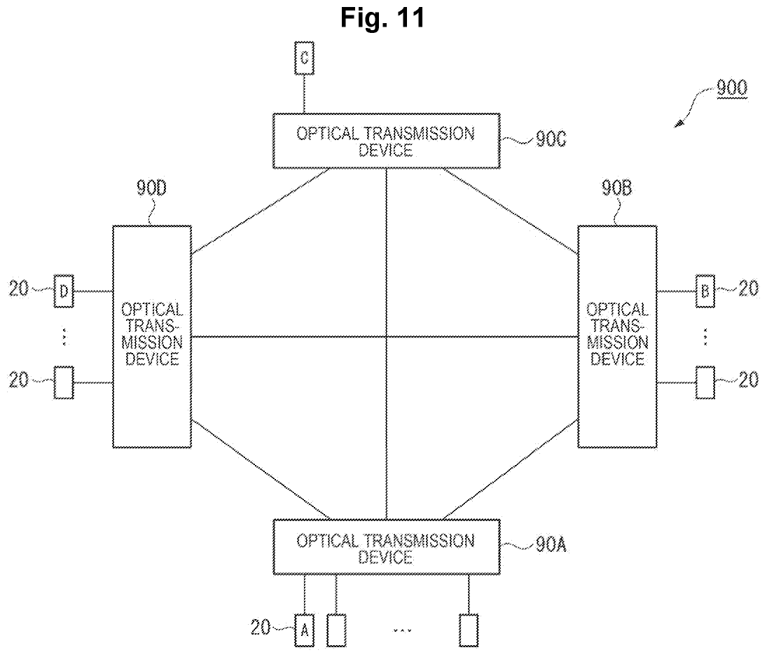

For example, in order to perform communication between a subscriber device 20A and a subscriber device 20C, conventionally, as illustrated in FIG. 11, the optical transmission device 10A to which the subscriber device 20A is connected and the optical transmission device 10C to which the subscriber device 20C is connected need to be directly connected by an optical fiber. On the other hand, in the optical transmission system 100 according to the present invention, an optical signal can be transmitted from the optical transmission device 10A to the optical transmission device 10C via the optical transmission device 10B or the optical transmission device 10D. Therefore, in order to implement communication between the optical transmission device 10A and the optical transmission device 10C, it is not necessary to connect the optical transmission device 10A and the optical transmission device 10C with an optical fiber. In the case of FIG. 5, it is possible to reduce the number of two optical fibers as compared with the conventional configuration of FIG. 11. In a case where the number of the optical transmission devices 10 is N, N (N−1)/2 optical fibers are required in the conventional method, but the number is reduced to N in the present embodiment.

As described above, when a signal addressed to the subscriber device 20 connected to another optical transmission device 10 is input, the wavelength multiplexing/separating unit 111 outputs the signal to the wavelength multiplexing/separating unit 111 corresponding to a path leading to another optical transmission device 10. Then, the signal is output from the wavelength multiplexing/separating unit 111 to the transmission path toward the other optical transmission device 10. Therefore, unlike the conventional case, communication via the base (optical transmission device 10) becomes possible. As a result, the number of paths (optical fibers) used for connection between the optical transmission devices 10 can be reduced.

In addition, in the optical transmission system 100 using the optical transmission device 10, multicast communication to a plurality of subscriber devices 20 connected to the same optical switch 14 can be realized in the downstream communication without adding a new configuration. For example, in the conventional technique disclosed in Patent Literature 1, it is necessary to separately prepare a coupler and connect the coupler to the optical switch 14. Therefore, the number of ports of the optical switch 14 is required more. On the other hand, in the optical transmission system 100 using the optical transmission device 10, it is possible to reduce the number of ports of the optical switch 14 required. For example, in a case where multicast communication is performed between a subscriber device 20A1 and a subscriber device 20A2 connected to the same optical switch 14, multicast can be realized only by setting the wavelength tunable filter 15 above the subscriber device 20A1 and the subscriber device 20A2 to select a wavelength used for multicast communication.

Further, in the conventional technique disclosed in Patent Literature 1, it is assumed that one wavelength passes through each port of the optical switch 14. On the other hand, the optical transmission device 10 operates without any problem even through a plurality of wavelengths at each port of the optical switch 14. As a result, for example, a coupler can be further attached to a port on the subscriber device side of the optical switch 14, and a plurality of subscriber devices 20 can be physically connected to one port. With this configuration, it is possible to reduce the number of ports of the optical switch 14 required to accommodate the same number of subscriber devices 20.

### Second Embodiment

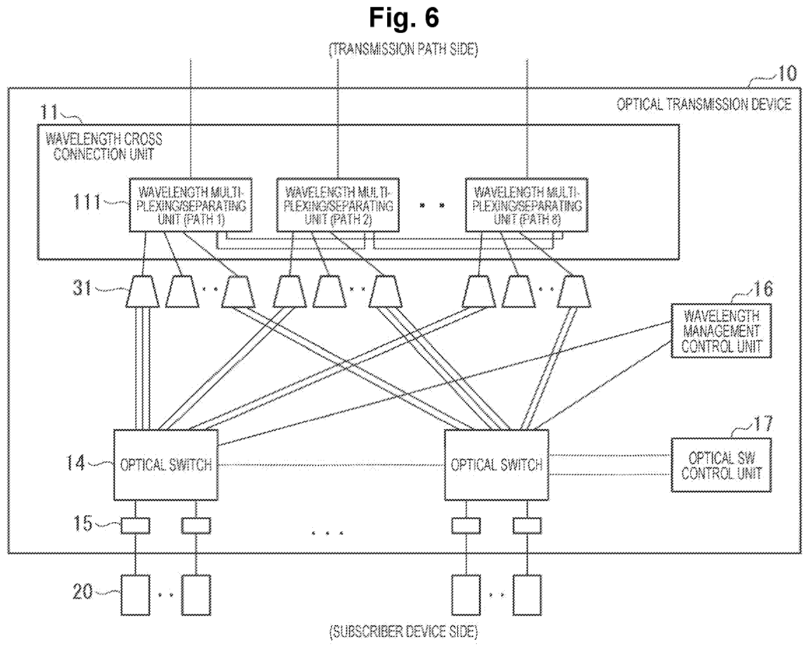

FIG. 6 is a diagram illustrating a configuration example of an optical transmission device 10 according to a second embodiment. The optical transmission device 10 in the second embodiment includes a wavelength selective transmission unit 31 instead of the coupler 13 in the first embodiment. Although the internal amplifier 12 is not illustrated in FIG. 6, the internal amplifier may be provided between the wavelength cross connection unit 11 and the wavelength selective transmission unit 31 as in the first embodiment. Other configurations of the optical transmission device 10 in the second embodiment are similar to those of the optical transmission device 10 in the first embodiment.

The wavelength selective transmission unit 31 is a specific example of a multiplexer/demultiplexer. When a wavelength-multiplexed optical signal is input from the transmission path side, the wavelength selective transmission unit 31 outputs a signal with a wavelength corresponding to each port from a plurality of ports on the side of the subscriber device. When a plurality of optical signals is input from a plurality of ports on the subscriber device side, the wavelength selective transmission unit 31 performs wavelength multiplexing on the input plurality of optical signals and outputs the multiplexed optical signals from the port on the transmission path side. The wavelength selective transmission unit 31 may be configured using, for example, a wavelength selective switch (WSS). The wavelength selective transmission unit 31 is provided between the wavelength cross connection unit 11 and the optical switch 14. The wavelength selective transmission unit 31 may be provided for each port on the subscriber side of the wavelength multiplexing/separating unit 111.

The optical transmission device 10 of the second embodiment configured as described above can achieve effects similar to those of the optical transmission device 10 of the first embodiment.

### Third Embodiment

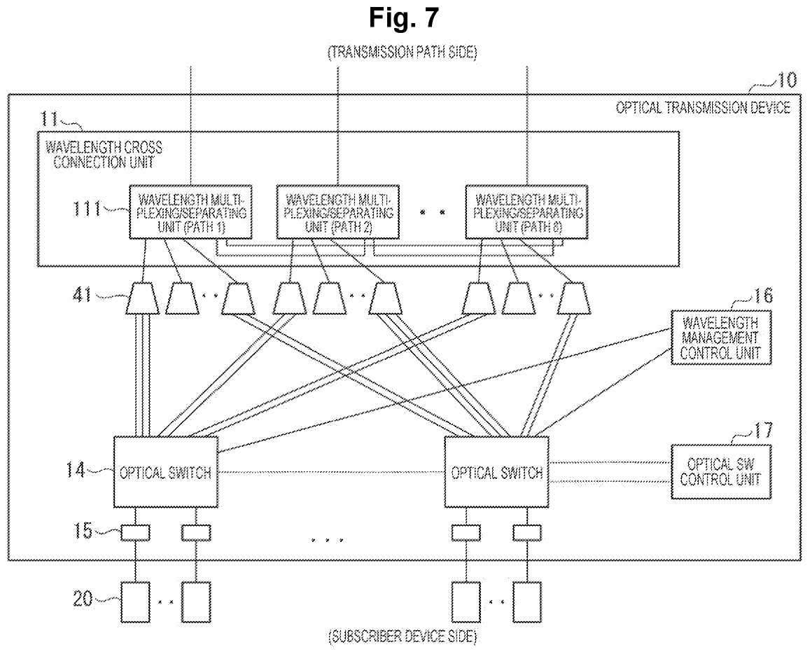

FIG. 7 is a diagram illustrating a configuration example of the optical transmission device 10 according to a third embodiment. The optical transmission device 10 according to the third embodiment includes an arrayed waveguide grating (AWG) 41 instead of the coupler 13 according to the first embodiment. Although the internal amplifier 12 is not illustrated in FIG. 7, the internal amplifier may be provided between the wavelength cross connection unit 11 and the AWG 41 as in the first embodiment. Other configurations of the optical transmission device 10 in the third embodiment are similar to those of the optical transmission device 10 in the first embodiment.

The AWG 41 is a specific example of the multiplexer/demultiplexer. When a wavelength multiplexed optical signal is input from the transmission path side, the AWG 41 demultiplexes the input optical signal to output a signal having a wavelength corresponding to each port from a plurality of ports on the subscriber device side. When a plurality of optical signals is input from a plurality of ports on the subscriber device side, the AWG 41 combines the plurality of input optical signals and outputs the combined optical signals from a port on the transmission path side. The AWG 41 is provided between the wavelength cross connection unit 11 and the optical switch 14. The AWG 41 may be provided for each port on the subscriber side of the wavelength multiplexing/separating unit 111.

The optical transmission device 10 of the third embodiment configured as described above can achieve effects similar to those of the optical transmission device 10 of the first embodiment.

### MODIFICATION EXAMPLES

The wavelength multiplexing/separating unit 111 of the wavelength cross connection unit 11 may not necessarily be connected to all the other wavelength multiplexing/separating units 111.

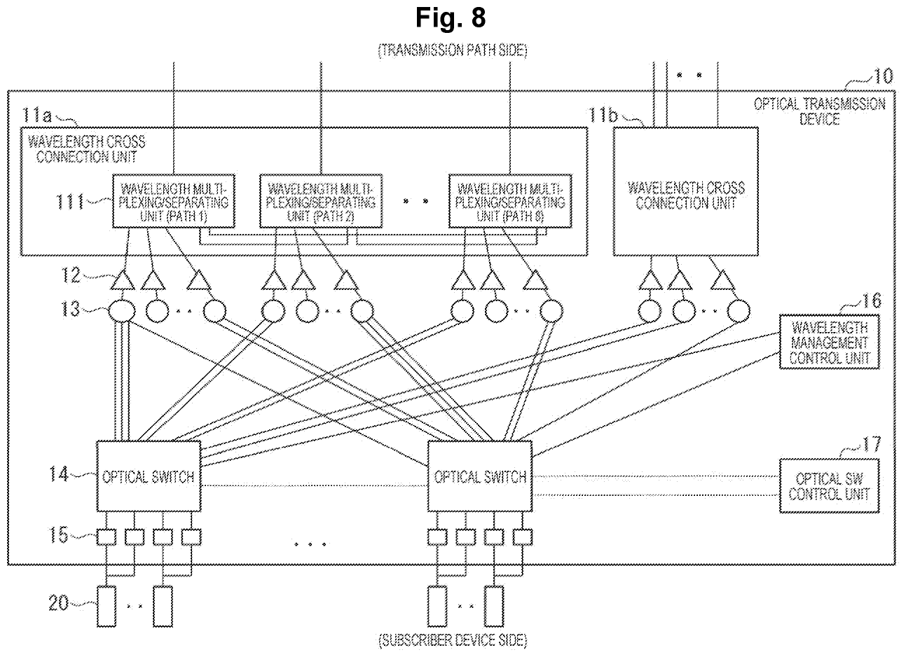

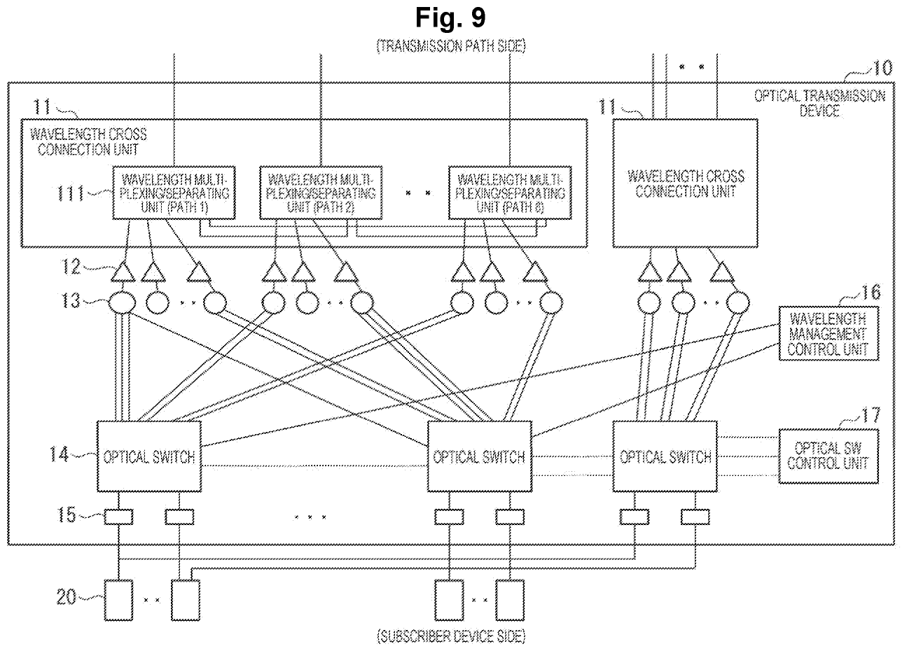

In the embodiment described above, the upstream communication and the downstream communication are performed by the same optical fiber in the transmission path, but the upstream communication and the downstream communication may be performed by different optical fibers. FIGS. 8 and 9 are diagrams illustrating a specific example of a configuration performed using different optical fibers for upstream communication and downstream communication in a transmission path. The optical transmission device 10 in FIGS. 8 and 9 includes a plurality of wavelength cross connection units 11.

In the examples of FIGS. 8 and 9, the optical transmission device 10 includes the wavelength cross connection unit 11 for upstream communication and a wavelength cross connection unit 11 for downstream communication. That is, the optical transmission device 10 includes two wavelength cross connection units 11. FIG. 8 illustrates a wavelength cross connection unit 11a for upstream communication and a wavelength cross connection unit 11b for downstream communication. As illustrated in FIG. 8, the wavelength cross connection unit 11a for upstream communication and the wavelength cross connection unit 11b for downstream communication may be connected to the same optical switch 14. In this case, the subscriber device 20 performs upstream communication and downstream communication via the same optical switch 14. As illustrated in FIG. 9, the wavelength cross connection unit 11a for upstream communication and the wavelength cross connection unit 11b for downstream communication may be connected to different optical switches 14. In this case, the subscriber device 20 performs upstream communication and downstream communication via different optical switches 14.

In a case where the transmission path side uses different optical fibers for the upstream communication and the downstream communication, and the subscriber device 20 transmits and receives signals of different wavelengths for the upstream communication and the downstream communication by one optical fiber, it is necessary to multiplex and demultiplex the signals of the upstream communication and the downstream communication somewhere between the subscriber device 20 and the wavelength cross connection unit 11, for example, as described in Patent Literature 1. In order to realize such a configuration, a device having a multiplexing and demultiplexing function is provided at an arbitrary position between the subscriber device 20 and the wavelength cross connection unit 11.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to an optical communication network using an optical switch.

### REFERENCE SIGNS LIST

100 Optical transmission system
10 Optical transmission device
11 Wavelength cross connection unit
12 Internal amplifier
13 Coupler
14 Optical switch
15 Wavelength tunable filter
16 Wavelength management control unit
17 Optical SW control unit
20 Subscriber device
31 Wavelength selective transmission unit
41 AWG

1. An optical transmission device comprising:
a wavelength cross connection unit that receives an optical signal transmitted from a first optical transmission device, separates the input optical signal according to a wavelength, and outputs each of the separated optical signals from a port corresponding to the wavelength; and
an optical switch that outputs an optical signal output from the wavelength cross connection unit from a port to which a destination subscriber device is connected, wherein
the wavelength cross connection unit outputs the optical signal toward the optical switch in a case where the optical signal is an optical signal addressed to a subscriber device connected under control of a host device, and outputs the optical signal toward a second optical transmission device different from the first optical transmission device in a case where the optical signal is not an optical signal addressed to a subscriber device connected under control of the host device.

2. The optical transmission device according to claim 1, wherein
the wavelength cross connection unit includes a plurality of wavelength multiplexing/separating units corresponding to the number of paths connected to other optical transmission lines, and
the wavelength multiplexing/separating unit outputs the optical signal toward the optical switch in a case where the input optical signal is an optical signal addressed to a subscriber device connected under control of the host device, and outputs the optical signal toward a wavelength multiplexing/separating unit connected to a path directed to a second optical transmission device different from the first optical transmission device in a case where the optical signal is not an optical signal addressed to a subscriber device connected under control of the host device.

3. The optical transmission device according to claim 1, further comprising:
a multiplexer/demultiplexer that inputs the optical signal output from the wavelength cross connection unit toward the optical switch, demultiplexes the optical signal into a plurality of optical signals according to a wavelength, and outputs the demultiplexed optical signals to the optical switch.

4. The optical transmission device according to claim 1, further comprising:
a wavelength tunable filter that is provided closer to a subscriber device than the optical switch and passes an optical signal with a wavelength assigned to the subscriber device connected to the optical transmission device.

5. The optical transmission device according to claim 4, wherein the wavelength tunable filter further passes a wavelength of an optical signal used for multicast.

6. A communication method to be executed by an optical transmission device including a wavelength cross connection unit and a plurality of optical switches, the method comprising:
receiving an optical signal transmitted from a first optical transmission device, separating the input optical signal according to a wavelength, and outputting each of the separated optical signals from a port corresponding to the wavelength by the wavelength cross connection unit;
outputting an optical signal output from the wavelength cross connection unit from a port to which a destination subscriber device is connected by the optical switch; and
outputting the optical signal toward the optical switch in a case where the optical signal is an optical signal addressed to a subscriber device connected under control of a host device, and outputting the optical signal toward a second optical transmission device different from the first optical transmission device in a case where the optical signal is not an optical signal addressed to a subscriber device connected under control of the host device by the wavelength cross connection unit.
